(19) United States
(12) Patent Application Publication
(10) Pub. No.: US 2024/0331162 A1
(43) Pub. Date: Oct. 3, 2024

(54) IMAGE PROCESSING DEVICE AND METHOD FOR INTEGRAL IMAGE PROCESSING, AND RECORDING MEDIUM

(71) Applicant: MOBILINT INC., Seoul (KR)

(72) Inventor: Dong Joo SHIN, Guri-si (KR)

(73) Assignee: MOBILINT INC., Seoul (KR)

(21) Appl. No.: 18/743,553

(22) Filed: Jun. 14, 2024

Related U.S. Application Data
(63) Continuation of application No. PCT/KR2022/020358, filed on Dec. 14, 2022.

(30) Foreign Application Priority Data
Dec. 14, 2021 (KR) 10-2021-0178903
Dec. 13, 2022 (KR) 10-2022-0173472

(51) Int. Cl. G06T 7/11; G06T 7/13

(52) U.S. Cl. CPC G06T 7/11; G06T 7/13; G06T 2207/20021

(57) ABSTRACT

A device for processing an integral image according to the present disclosure may include a memory configured to store at least one process for processing an integral image; and a processor configured to perform an operation according to the process, wherein the processor includes: a generation module configured to split an input image into a plurality of areas, set one of at least one intersection where the plurality of areas intersect as a starting point for generating an integral image, and generate a plurality of integral images for the plurality of areas based on the starting point; and a calculation module configured to calculate a sum of pixel values in a specific area of the input image using the plurality of integral images.

### CROSS-REFERENCE TO RELATED APPLICATIONS

The present application is a continuation of International Patent Application No. PCT/KR2022/020358, filed on Dec. 14, 2022, which is based upon and claims the benefit of priority to Korean Patent Application Nos. 10-2021-0178903 filed on Dec. 14, 2021 and 10-2022-0173472 filed on Dec. 13, 2022. The disclosures of the above-listed applications are hereby incorporated by reference herein in their entirety.

### BACKGROUND

### 1. Technical Field

The present disclosure relates to an image processing device and a method for integral image processing, and a recording medium, and more particularly, to an image processing device and a method for integral image processing, and a recording medium, which generates an integral image using from an input image, and obtaining a sum of pixel values in a random area of the input image using the generated integral image.

### 2. Description of Related Art

An integral image is an image generated by accumulating all pixel values of an input image contained in a rectangular area from a reference coordinate to the corresponding coordinate, and a concept first proposed by “Summed-area tables for texture mapping, Crow et al, SIGGRAPH '84: Proceedings of the 11th annual conference on Computer graphics and interactive techniques, pp. 207-212”. The integral image allows a sum of pixel values within an arbitrary image area to be calculated with a predetermined number of operations regardless of the size of the area. The sum of pixel values within the predetermined area of an image is often used as useful information in image processing, and representative examples include Haar-like Feature and SURF.

A limitation in using the integral image is that the amount of memory required to store the integral image is much larger than that for storing the input image, and also increases rapidly with the size of the image. While the amount of data required to store each pixel value of an existing input image is determined by the maximum value of one pixel value, in an integral image, the sum of the pixel values in the area is stored, so the maximum value of this value is much greater than the maximum value of the pixel value. Therefore, there is a need to reduce the amount of memory required to store the integral image. In addition, because each value of the integral image is affected by the previous value, parallelization beyond a certain level is impossible. Therefore, an integral image generation method that can increase parallelism is needed to be proposed. This need has become increasingly important as the quality of images used in image processing has increased significantly.

### SUMMARY

A technical problem to solve by the present disclosure is to provide an image processing device and a method for integral image processing, and a recording medium, which can reduce the amount of memory required to store an integral image and increase parallelism of the integral image generation.

Another technical problem to solve by the present disclosure is to provide an image processing device and a method for integral image processing, and a recording medium, which can generate an integral image from an input image and obtain a sum of pixel values in a random area of the input image using the generated integral image.

A device for processing an integral image according to the present disclosure may include a memory configured to store at least one process for processing an integral image; and a processor configured to perform an operation according to the process, wherein the processor includes: a generation module configured to split an input image into a plurality of areas, set one of at least one intersection where the plurality of areas intersect as a starting point for generating an integral image, and generate a plurality of integral images for the plurality of areas based on the starting point; and a calculation module configured to calculate a sum of pixel values in a specific area of the input image using the plurality of integral images.

In this case, the input image may be split into four split areas, and the generation module may progress the generation of the integral image for the four split areas in parallel manner.

Furthermore, a reference point of the generation of the integral image for the four split areas may be set for each of the four split areas, and be a pixel of which distance from the starting point is closest among the pixels included in the respective four split areas.

Furthermore, a straight line intersecting the plurality of areas may represent a boundary of two straight lines defining a pixel, not a line defining a specific pixel, and the pixel included in any one of the plurality of areas may not be included in a remaining area among the plurality of areas.

Furthermore, based on the pixel value of an area of the input image being not changed, the input image may be split into an area of which the pixel value is not change and a remaining area, and the generation of the integral image may be performed only for the remaining area.

Furthermore, the plurality of areas may include a first area and a second area, which are different with each other, an average value of the pixels included in the first area may be greater than an average value of the pixels included in the second area, and an area of the first area may be smaller than an area of the second area.

Furthermore, a method for processing an integral image perform by a processor of a device according to the present disclosure may include splitting, by a generation module of the processor, an input image into a plurality of areas; setting, by the generation module, one of at least one intersection where the plurality of areas intersect as a starting point for generating an integral image; generating, by the generation module, a plurality of integral images for the plurality of areas based on the starting point; and calculating, by a calculation module of the processor, a sum of pixel values in a specific area of the input image using the plurality of integral images.

Furthermore, a recording medium storing a program combined with a hardware computer device for executing a method for processing an integral image according to the present disclosure may include performing a first process of splitting an input image into a plurality of areas; performing a second process of setting one of at least one intersection where the plurality of areas intersect as a starting point for generating an integral image; performing a third process of generating a plurality of integral images for the plurality of areas based on the starting point; and performing a fourth process of calculating a sum of pixel values in a specific area of the input image using the plurality of integral images.

### BRIEF DESCRIPTION OF THE FIGURES

FIG. 1 is a block diagram of a server implementing the image processing device of the present disclosure.

FIG. 2 is a block diagram of a terminal implementing the image processing device of the present disclosure.

FIG. 3 is a diagram illustrating the concept of an integral image.

FIG. 4 is a diagram illustrating a method of calculating a sum of pixel values in a random image area using the generated integral image.

FIG. 5 is a flowchart illustrating an image processing method according to the present disclosure.

FIG. 6 is a schematic diagram illustrating a method for generating an integral image according to the image processing method for processing an integral image according to the present disclosure.

FIG. 7 is a diagram illustrating a method of calculating the sum of pixel values in a random image area in the image processing method for integral image processing according to the present disclosure.

FIG. 8 is a diagram schematically illustrating a configuration of an image processing device for processing an integral image according to the present disclosure.

FIG. 9 is a diagram showing that generation of an integral image is performed in parallel in the image processing method for processing an integral image according to the present disclosure.

FIG. 10 is a diagram illustrating a decrease in the maximum range of an integral image according to the image processing method for processing an integral image according to the present disclosure.

FIG. 11 is a conceptual diagram illustrating an example in which the amount of calculation is reduced according to the image processing method of the present disclosure.

FIG. 12 is a conceptual diagram illustrating an image splitting method according to the present disclosure.

### DETAILED DESCRIPTION

Terms or words used in this specification and claims should not be construed as limited to their usual or dictionary meanings, and the inventor appropriately defines the concept of terms in order to explain his or her invention in the best way. It should be interpreted with meaning and concept consistent with the technical idea of the present disclosure based on the principle that it can be done.

Throughout the specification, when a part is said to “include” a certain element, this means that it may further include other elements rather than excluding other elements, unless specifically stated to the contrary. In addition, terms such as “ . . . portion”, “ . . . unit”, “module”, and “device” used in the specification refer to a unit that processes at least one function or operation, which refers to hardware, software, or a combination of hardware and software. It can be implemented as:

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network. Furthermore, when a certain part “includes” a certain element, other elements are not excluded unless explicitly described otherwise, and other elements may in fact be included.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

Hereinafter, operation principles and embodiments of the present disclosure will be described with reference to the accompanying drawings.

In this specification, ‘the image processing device according to the present disclosure’ includes all various devices that can perform computational processing and provide results to a user. For example, the image processing device according to the present disclosure may include all of a computer, a server device, and a portable terminal, or may be any one of the form.

Here, the computer may include, for example, a laptop equipped with a web browser, a desktop, a laptop, a tablet PC, a slate PC, and the like.

The server device is a server that processes information by communicating with external devices, and may include an application server, a computing server, a database server, a file server, a mail server, a proxy server, a web server, and the like.

The portable terminal is, for example, a wireless communication device that guarantees portability and mobility, and may include all types of handheld wireless communication devices such as PCS (Personal Communication System), GSM (Global System for Mobile communications), PDC (Personal Digital Cellular), and PHS (Personal Handyphone System)), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, a smart phone, and the like and wearable devices such as watches, rings, bracelets, anklets, necklaces, glasses, contact lenses, head-mounted devices (HMD), or the like.

Hereinafter, an image processing device according to the present disclosure will be described. Specifically, the image processing device according to the present disclosure may be implemented in at least one of a server and a terminal. Additionally, some functions of the image processing device according to the present disclosure may be implemented in a server, and the remaining functions may be implemented in a terminal.

Hereinafter, the above-described server and terminal will be described in detail.

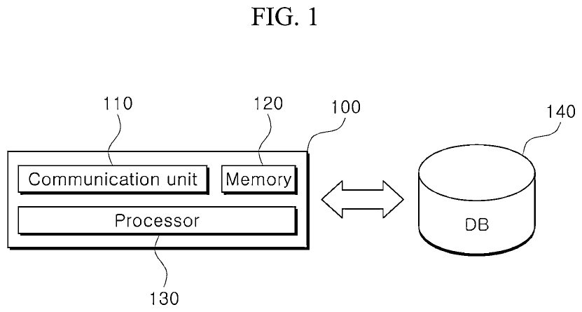

FIG. 1 is a block diagram of a server implementing the image processing device of the present disclosure.

The server 100 according to the present disclosure may include at least one of a communication unit 210, a memory 120, and a processor 130.

The communication unit 110 may communicate with at least one of a terminal, an external storage (e.g., a database 140), an external server, and a cloud server.

Meanwhile, the external server or the cloud server may be configured to perform at least a portion of the function of the processor 130. In other words, data processing or data computation may be performed by the external server or the cloud server, and the present disclosure does not place any special restrictions on this scheme.

Meanwhile, the communication unit 110 may support various communication schemes according to the communication standard of the communicating object (e.g., electronic device, external server, device, etc.).

For example, the communication unit 110 is configured to communicate with a communication target by using at least one of WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G (5th Generation Mobile Telecommunication), Bluetooth™, RFID (Radio Frequency Identification), Infrared Data Association (IrDA), UWB (Ultra-Wideband), ZigBee, NFC (Near Field Communication), Wi-Fi Direct, or Wireless USB (Wireless Universal Serial Bus) technology.

Next, the memory 120 may be configured to store various types of information related to the present invention. In the present disclosure, the memory 120 may be provided in the device itself according to the present disclosure. Alternatively, at least a portion of the memory 120 may represent at least one of a database (DB) 140 and a cloud storage (or cloud server). In other words, the memory 120 is sufficient as a space for storing information necessary for the device and method according to the present disclosure, and it can be understood that there are no restrictions on physical space. Accordingly, hereinafter, the memory 120, the database 140, the external storage, and the cloud storage (or cloud server) will not be separately distinguished, and will be referred to as the memory 120.

In addition, the memory 120 stores an algorithm for controlling the operation of components within the device or data about a program that reproduces the algorithm.

Next, the processor 130 may be configured to control the overall operation of the device related to the present invention. The processor 130 may process signals, data, information, and the like input or output through the components described above, or provide or process appropriate information or functions to a user.

The processor 130 may include at least one CPU (Central Processing Unit) and perform functions according to the present disclosure.

At least one component may be added or deleted in response to the performance of the components shown in FIG. 1. Additionally, it will be easily understood by those skilled in the art that the mutual positions of the components may be changed in response to the performance or structure of the device.

Hereinafter, a terminal implementing the image processing device of the present disclosure will be described in detail.

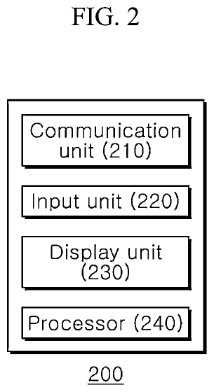

FIG. 2 is a block diagram of a terminal implementing the image processing device of the present disclosure.

Referring to FIG. 2, the terminal 200 according to the present disclosure may include a communication unit 210, an input unit 220, a display unit 230, and a processor 240. The components shown in FIG. 2 are not essential for implementing the image processing device according to the present disclosure, so the terminal described in this specification may have more or fewer components than the components listed above.

Among the components, the communication unit 210 may include one or more components that enable communication with an external device, for example, at least one of a broadcast reception module, a wired communication module, a wireless communication module, a short-range communication module, or a location information module.

The wired communication module is a variety of wired communication modules, such as a local area network (LAN) module, a wide area network (WAN) module, or a value added network (VAN) module, as well as a USB (It may include various cable communication modules such as Universal Serial Bus (HDMI), High Definition Multimedia Interface (HDMI), Digital Visual Interface (DVI), recommended standard 1302 (RS-1302), power line communication, or plain old telephone service (POTS).

The wireless communication module may include a wireless communication module that supports various wireless communication schemes such as GSM (global System for Mobile Communication), CDMA (Code Division Multiple Access), WCDMA (Wideband Code Division Multiple Access), UMTS (universal mobile telecommunications system), TDMA (Time Division Multiple Access), LTE (Long Term Evolution), 4G, 5G, 6G, and the like, in addition to the Wi-Fi module and the WiBro (Wireless Broadband).

The input unit 220 is for inputting image information (or signal), audio information (or signal), data, or information input from a user, and may include at least one camera, at least one microphone, and a user input unit. The voice data or image data collected from the input unit may be analyzed and processed as a user's control command.

The camera processes image frames, such as still images or moving images, obtained by an image sensor in shooting mode. The processed image frame may be displayed on the display unit 230, which will be described later, or may be stored in the memory.

The microphone processes external acoustic signals into electrical voice data. Processed voice data may be used in a variety of ways depending on the function being performed (or the application being executed) on the device. Meanwhile, various noise removal algorithms may be implemented in the microphone to remove noise generated in the process of receiving an external acoustic signal.

The user input unit is for receiving information from a user. When information is input through the user input unit, the processor 240 may control the operation of the device to correspond to the input information. The user input unit may include a hardware-type physical key (e.g., button, dome switch, jog wheel, jog switch, etc. located on at least one of the front, back, and sides of the device) and a software-type touch key. As an example, the touch key may include a virtual key, a soft key, or a visual key displayed on a touch screen-type display unit through software processing, or a touch key placed in other parts of the touch screen. Meanwhile, the virtual key or visual key may be displayed on the touch screen in various forms, for example, graphics, text, icons, videos, or a combination thereof.

The display unit 230 is intended to generate an output related to vision, hearing, or tactile sensation, and may include at least one of a display unit, an audio output unit, a Haptic module, or an optical output unit. The display unit 230 may implement a touch screen by forming a layered structure or being integrated with the touch sensor. This touch screen functions as a user input unit that provides an input interface between the device and the user, and may simultaneously provide an output interface between the device and the user.

The display unit 230 displays (outputs) information processed by the device. For example, the display unit 230 may display execution screen information of an application program (for example, an application) running on the device, or UI (User Interface) and GUI (Graphic User Interface) information according to such execution screen information.

In addition to the above-described components, the above-described terminal may further include an interface unit and a memory.

The interface unit serves as a passageway for various types of external devices connected to the device. The interface unit may include a wired/wireless headset port, an external charger port, a wired/wireless data port, a memory card port, a port for connecting a device equipped with an identification module (SIM), an audio I/O (Input/Output) port, a video input/output (I/O) port, and an earphone port. The device may perform an appropriate control related to an external device connected to the interface unit.

The memory may store data supporting various functions of the device, a program for the operation of the processor 240, input/output data (e.g., music files, still images, videos, etc.), a plurality of application programs (application program or application) running on the device, data for operation of the device, and commands may be stored. At least some of these applications may be downloaded from an external server via wireless communication.

In addition, the memory stores data about an algorithm for controlling the operation of components within the device or a program that reproduces the algorithm.

The memory may include at least one type of storage medium including a memory of a flash memory type, a hard disk type, a solid state disk (SSD) type, an SDD type (Silicon Disk Drive type), or a multimedia card micro type, a card micro type and a card type memory (e.g. SD or XD memory, etc.), random access memory (RAM), static random access memory (SRAM), read-only memory (ROM), EEPROM (electrically It may include at least one type of storage medium among erasable programmable read-only memory (PROM), programmable read-only memory (PROM), magnetic memory, magnetic disk, and optical disk. In addition, the memory may be a database that is separate from the device, but is connected wired or wirelessly.

Meanwhile, the above-described terminal includes a processor 240.

The processor 240 may perform an operation according to at least one process for processing the integral image stored in the memory. In particular, the processor 240 may include a generation module 810 configured to split an input image into a plurality of areas, set one of at least one intersection where the plurality of areas intersect as a starting point for generating an integral image, and generate a plurality of integral images for the plurality of areas based on the starting point and a calculation module 820 configured to calculate a sum of pixel values in a specific area of the input image using the plurality of integral images.

The processor 240 may control any one or a combination of the components described above in order to implement various embodiments according to the present disclosure described in the drawings below on the device.

Meanwhile, at least one component may be added or deleted in response to the performance of the components shown in FIGS. 1 and 2. Additionally, it will be easily understood by those skilled in the art that the mutual positions of the components may be changed in response to the performance or structure of the device.

Hereinafter, the embodiments of the present disclosure will be described in detail with reference to the attached drawings.

Before describing the present disclosure, the conventional integral image generation method will be described.

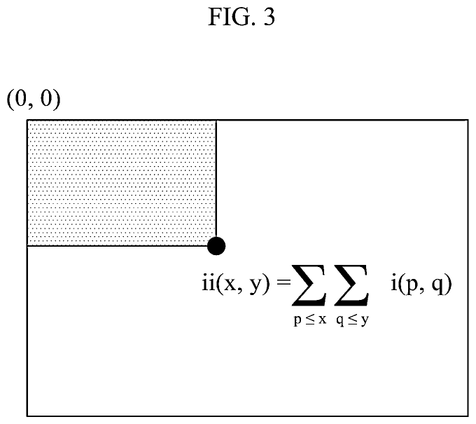

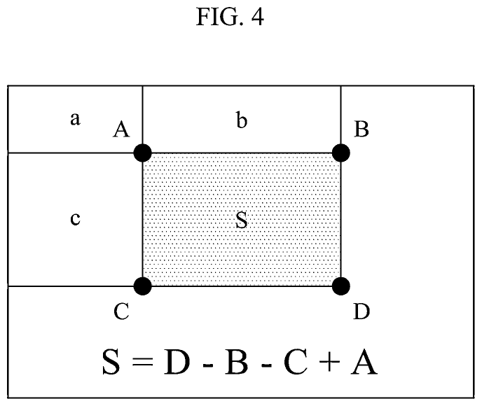

FIG. 3 is a diagram illustrating the concept of an integral image, and FIG. 4 is a diagram illustrating a method of calculating a sum of pixel values in a random image area using the generated integral image.

Referring to FIG. 3, the value ii (x, y) of a specific coordinate (x, y) of an integral image is represented as an accumulated value of all pixel values included in the rectangular area from a reference coordinate (0, 0) of the input image to (x, y). This may be expressed as Equation 1 below:

$$ii ( x , y ) = {\sum }_{p \leq x} {\sum }_{q \leq y} i ( p , q ) \qquad [ Equation 1 ]$$

In Equation 1 above, the reference coordinate (0, 0) may be set to one of four vertices of the input image. Using the integral image, the sum of pixel values for a random area of the input image may be obtained using Equation 1 above.

FIG. 4 is a diagram illustrating a method of calculating the sum of pixel values in a random area of an input image using an integral image.

Referring to FIG. 4, in order to find the sum S of pixel values in a random area of the input image, only four values A, B, C, and D of the integral image corresponding to the vertices of the random area are required. In FIG. 2, when a, b, c, and S are the pixel values of each rectangular area shown in the drawing, A, B, C, and D of the integrated image corresponds to a, (a+b), (a+c), and (a+b+c+S), respectively, and may be calculated as S=D−B−C+A.

Considering that the maximum value of D is the entire input image, the minimum amount of memory required to store the above-described integral image needs to be an amount capable of storing the integral image for the entire input image.

The present disclosure provides an image processing method that reduces the amount of memory required for storing the integral image and enables parallelization of operations for generating the integral image.

Hereinafter, the image processing method according to the present disclosure will be described.

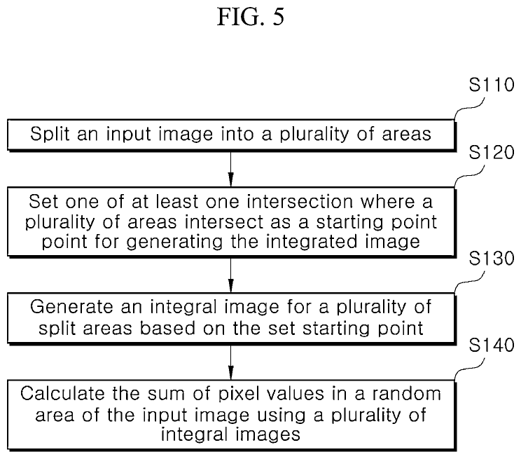

FIG. 5 is a flowchart illustrating an image processing method according to the present disclosure.

Referring to FIG. 5, the generation module 810 proceeds with splitting the input image into a plurality of areas (step S110).

The input image may be split into a plurality of rectangular areas. Depending on the size of the image and the size and number of split areas, the shape of the split area may be rectangular or square.

Meanwhile, the size and shape of the plurality of split areas may all be the same, or the size and shape of at least some areas may be different from the size and shape of the remaining areas.

In one embodiment, the input image may be split into four rectangular areas.

In one embodiment, the input image may be split into four areas based on a horizontal center line and a vertical center line of the input image.

Meanwhile, the straight line splitting the split areas represents a boundary of two straight lines defining a pixel, not a line defining a specific pixel, so there may not be a pixel that is overlappingly included in each split area. That is, a pixel included in any one of each split area is not included in any of the remaining areas of each split area.

Meanwhile, the reference of splitting the image may be set based on at least one of a pixel value for each area of the input image, a pixel value distribution, and a pixel value change amount. This will be described later.

Next, the generation module 810 performs setting one of at least one intersection where a plurality of areas intersect as a starting point for generating the integrated image (step S120).

The starting point may be a point where all of the plurality of areas come into contact.

For example, in the case that the input image is split into two areas, there may be a plurality of intersection points.

For another example, in the case that the input image is split into four areas, there may be one intersection.

In one embodiment, in the case that the input image is split into four areas based on the horizontal center line and the vertical center line of the input image, the starting point may be the center coordinate of the image. However, the starting point does not necessarily need to be the center coordinate of the image.

Next, the generation module 810 performs generating an integral image for a plurality of split areas based on the set starting point (step S130).

The integral image for each of the plurality of split areas may be generated according to Equation 1 described above. Here, the reference point for generating the integral image of each of the plurality of split areas may be set based on the starting point.

Here, the starting point may not specify a pixel of the image. The starting point is the intersection point between virtual straight lines splitting the input image. Since the straight lines are not lines defining a specific pixel, but are boundaries of two straight lines defining a pixel, the intersection of the straight lines does not define a specific pixel.

The reference point for generating the integral image of each split area is different, and may be set based on the starting point. Specifically, the reference point for generating the integrated image of each split area may be set as the pixel closest to the starting point among the pixels present in each split area.

For example, in the case that the input image is split into four areas based on the horizontal center line and the vertical center line of the input image, four pixels correspond to the intersection based on the intersection of the four images. Here, the pixel of each split image corresponding to the intersection point may be the pixel with the smallest distance from the intersection point. Each of the four pixels corresponding to the intersection point becomes the reference point for generating the integral image of each segmented image.

According to the method described above, each integral image generated from each split image does not contain an overlapping specific pixel, and even in the case that the integral image is generated by splitting the image, there is no risk of generating the integral image by missing a specific pixel.

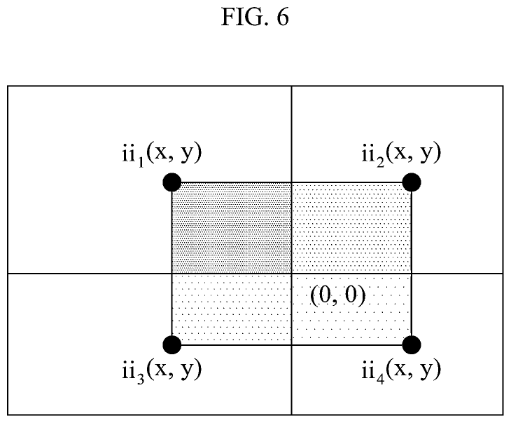

FIG. 6 is a schematic diagram illustrating a method for generating an integral image according to the image processing method for processing an integral image according to the present disclosure.

Referring to FIG. 6, an integral image is generated by splitting the input image into four square areas. In this case, the reference coordinate for generating each integral image is the intersection point of the four split areas. For convenience, the intersection point is shown as one in the drawing, but actually, four pixels, not one pixel, correspond to the intersection point, and the four pixels serve as the reference points for generating the respective split integral image. The straight line dividing the split area also represents the boundary of two straight lines defining a pixel, not a line defining a specific pixel. Therefore, there are no pixels overlapped in each split area. The method of generating the integral image from each split area is the same as the method of generating a single split area.

Finally, the calculation module 820 performs calculating the sum of pixel values in a random area of the input image using a plurality of integral images (step S140).

The sum of pixel values in a random area of the input image may be calculated by combining the result values distributed through each split area. Specifically, the sum of the pixel values of any one of the split areas and the area where the random area overlaps may be calculated using the integral image for the one area. In the above-described manner, the sum of the pixel values corresponding to each of the plurality of split areas is calculated, and then the pixel values corresponding to all split areas are combined to calculate the sum of the pixel values for the random area.

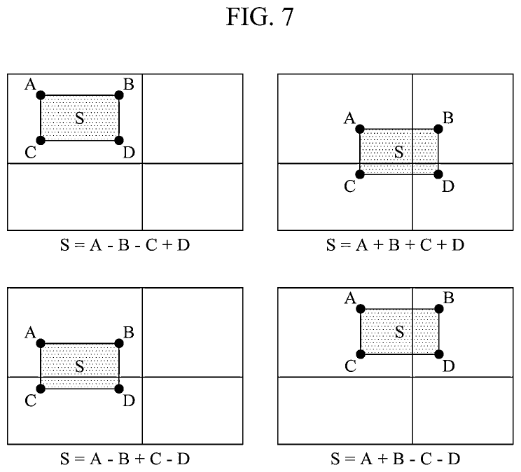

FIG. 7 is a diagram illustrating a method of calculating the sum of pixel values in a random image area in the image processing method for integral image processing according to the present disclosure.

For example, referring to FIG. 7, in the case of trying to find the sum of pixel values in a random area of the input image through four split integral images, there are various cases, but all the cases may be explained by using the four cases shown in FIG. 7.

Referring to the upper left drawing of FIG. 7, in the case that a random area overlaps only in an upper left area, the sum of pixel values for the random area may be calculated using only the integrated image for the upper left area.

Referring to the lower left drawing of FIG. 7, in the case that a random area overlaps only in an upper left area and a lower left area, the sum of pixel values for the random area may be calculated using only the integrated image for the upper left area and the lower left area.

Referring to the upper right drawing of FIG. 7, in the case that a random area overlaps in each of the four split areas, the sum of pixel values for the random area may be calculated using the respective integral image for each split area.

Referring to the lower right drawing of FIG. 7, in the case that a random area overlaps only in an upper left area and an upper right area, the sum of pixel values for the random area may be calculated using only the integrated image for the upper left area and upper right area.

In this case, four values of the integral image and three time of calculations are required, which are the same as the method described in FIGS. 3 and 4. However, according to the present disclosure, parallel processing for each partition area is available.

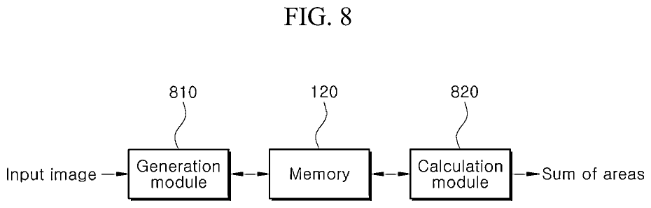

FIG. 8 is a diagram schematically illustrating a configuration of an image processing device for processing an integral image according to the present disclosure.

Referring to FIG. 8, the generation module 810 may receive an input image and generate four integral images by the method shown in FIG. 6. However, the number of images split by the integral image generator is not limited to four. As described in FIGS. 5 to 7, the generation module 810 may split the input image into a various number of split areas and then generate an integral image.

Meanwhile, the generated integral image is stored in the memory. The calculation module 820 calculates the sum of pixel values of a random area of the required input image through the generated integral image. The method of calculating the area sum follows what is explained in FIG. 7.

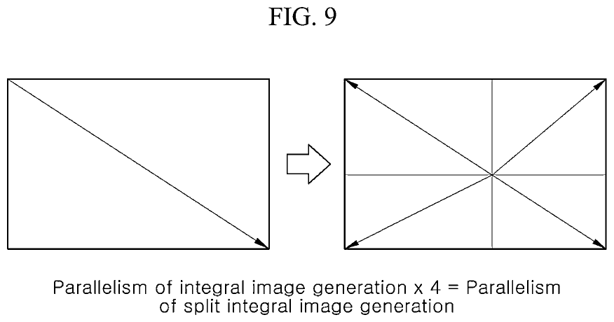

FIG. 9 is a diagram showing that generation of an integral image is performed in parallel in the image processing method for processing an integral image according to the present disclosure.

Referring to FIG. 9, the integral image of the four split areas may be generated completely independently of each other, so parallelism may be increased by up to 4 times.

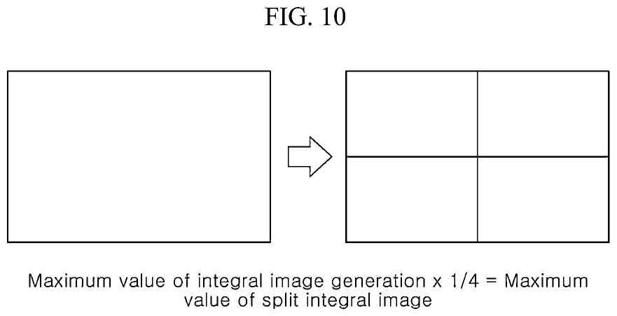

FIG. 10 is a diagram illustrating a decrease in the maximum range of an integral image according to the image processing method for processing an integral image according to the present disclosure.

Referring to FIG. 10, when four split areas are split to have the same size, each split area has pixels reduced to ¼ of the original area. Therefore, the maximum cumulative sum of pixel values that the values of the integral image may have is also reduced to ¼ compared to the value of the existing integral image.

Meanwhile, the present disclosure may reduce the amount of calculation for calculating the sum of pixel values of the input image compared to the conventional method.

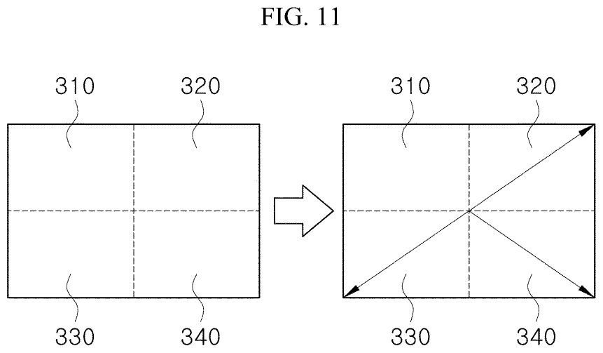

FIG. 11 is a conceptual diagram illustrating an example in which the amount of calculation is reduced according to the image processing method of the present disclosure.

Referring to FIG. 11, the pixel value of some areas of the input image may not change. For example, the pixel value of an area 310 among the plurality of split areas 310 to 340 does not change. In this case, the sum of pixel values for a random area of the input area may be calculated simply by generating an integral image for the remaining areas 320 to 340 excluding the area 310.

In the case of the conventional method described in FIGS. 3 and 4, it is inevitable to generate an integral image for the area 310 where the pixel value does not change.

Considering this, the image processing method according to the present disclosure may omit calculations for some areas where pixel values do not change, thereby reducing the amount of calculation for calculating the sum of pixel values of a random area.

Furthermore, according to the present disclosure, an input image may be split in a direction that minimizes the amount of memory or the amount of computation required to implement the image processing device.

Specifically, according to the present disclosure, in the case of receiving an input image, the image processing device uses image scanning to determine an area where the pixel value does not change, an area where the size of the pixel value is greater or smaller than other areas, and an area where the amount of change in the pixel value is greater or smaller than other areas.

Thereafter, the calculation module 820 may split the image based on the specific area.

In one embodiment, in the case that the pixel values of some areas of the input image do not change, the input image may be split into an area where the pixel values do not change and the remaining area. Here, the remaining area may include a plurality of split areas.

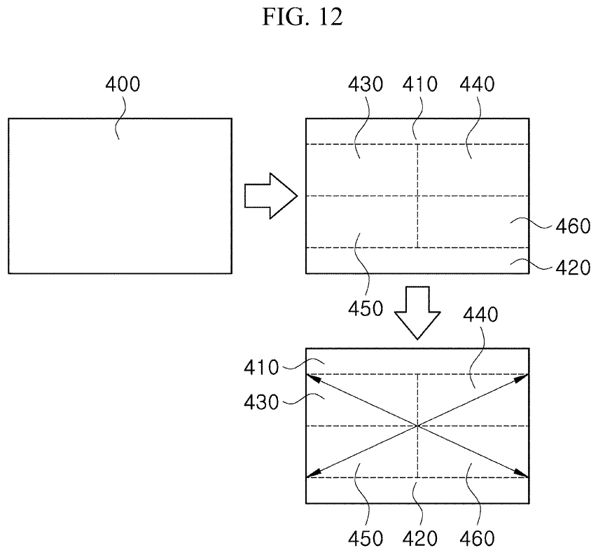

For example, referring to FIG. 12, in the case that the pixel values of top and bottom areas 410 and 420 of the input image 400 do not change, the input area may be split into the top and bottom areas 410 and 420 where the pixel values do not change, and the remaining areas 430 to 460 where pixel values change. Thereafter, the integral image generation may be performed only for the remaining areas 430 to 460. Through this, the present disclosure may minimize the amount of computation by splitting the image to selectively generate an integral image only in areas where pixel values change in the input image.

In another embodiment, the split of the input image may be performed in a direction that minimizes the maximum value among the sum of pixel values of each split area. Specifically, when splitting an image, the area of the area with a high average pixel value, which is composed of pixels with large pixel values, is split relatively smaller, and the area of the area with a low average pixel value, which is composed of pixels with small pixel values, is split relatively larger.

As a result, the plurality of areas into which the input image is split includes a first area and a second area, which are different with each other, and the average pixel value of the pixels included in the first area is greater than the average pixel value of the pixels included in the second area. And the area of the first area may be smaller than the area of the second area.

For example, in the case that the upper left area of the input image includes a pixel with a greater pixel value, and the lower right of the input image includes a pixel with small pixel value, the image may be split so that the area of the upper left area is relatively small, and the area of the lower right area is relatively large. Through this, according to the present disclosure, the amount of memory required for storing integral image may be minimized.

As described above, according to the present disclosure, the parallelism of integral image generation can be increased and the amount of memory required to store the integral image can be reduced.

In addition, in the process of calculating the sum of pixel values in a random area through the split integral image generation method and the split integral image, there is no increase in the amount of calculation or memory access compared to the existing integral image.

Furthermore, according to the present disclosure, the amount of computation may be reduced by splitting the image differently depending on the property of the input image. Meanwhile, the disclosed embodiments may be implemented in the form of a recording medium that stores instructions executable by a computer. Instructions may be stored in the form of program codes, and when executed by a processor, may create program modules to perform operations of the disclosed embodiments. The recording medium may be implemented as a computer-readable recording medium.

The computer-readable recording medium includes all types of recording media storing instructions that can be decoded by a computer. For example, there may be Read Only Memory (ROM), Random Access Memory (RAM), magnetic tape, magnetic disk, flash memory, optical data storage device, and the like.

Although the present disclosure has been described in detail through preferred embodiments, the present disclosure is not limited thereto, and various modifications and applications may be made without departing from the technical spirit of the present disclosure, as may be understood in the technical field to those skilled in the art. Therefore, the true scope of protection of the present disclosure should be interpreted in accordance with the following claims, and all technical ideas within the equivalent scope should be interpreted as being included in the scope of rights of the present disclosure.

What is claimed is:

1. A device for processing an integral image, comprising:
a memory configured to store at least one process for processing an integral image; and
a processor configured to perform an operation according to the process,
wherein the processor includes:
a generation module configured to split an input image into a plurality of areas, set one of at least one intersection where the plurality of areas intersect as a starting point for generating an integral image, and generate a plurality of integral images for the plurality of areas based on the starting point; and
a calculation module configured to calculate a sum of pixel values in a specific area of the input image using the plurality of integral images.

2. The device of claim 1, wherein,
the input image is split into four split areas, and
the generation module progresses the generation of the integral image for the four split areas in parallel manner.

3. The device of claim 2, wherein a reference point of the generation of the integral image for the four split areas is set for each of the four split areas, and is a pixel of which distance from the starting point is closest among the pixels included in the respective four split areas.

4. The device of claim 1, wherein,
a straight line intersecting the plurality of areas represents a boundary of two straight lines defining a pixel, not a line defining a specific pixel, and
the pixel included in any one of the plurality of areas is not included in a remaining area among the plurality of areas.

5. The device of claim 1, wherein,
based on the pixel value of an area of the input image being not changed, the input image is split into an area of which the pixel value is not change and a remaining area, and
the generation of the integral image is performed only for the remaining area.

6. The device of claim 1, wherein,
the plurality of areas includes a first area and a second area, which are different with each other,
an average value of the pixels included in the first area is greater than an average value of the pixels included in the second area, and
an area of the first area is smaller than an area of the second area.

7. A method for processing an integral image perform by a processor of a device, comprising:
splitting, by a generation module of the processor, an input image into a plurality of areas;
setting, by the generation module, one of at least one intersection where the plurality of areas intersect as a starting point for generating an integral image;
generating, by the generation module, a plurality of integral images for the plurality of areas based on the starting point; and
calculating, by a calculation module of the processor, a sum of pixel values in a specific area of the input image using the plurality of integral images.

8. The method of claim 7, wherein
the input image is split into four split areas, and
the generation module progresses the generation of the integral image for the four split areas in parallel manner.

9. The method of claim 8, wherein a reference point of the generation of the integral image for the four split areas is set for each of the four split areas, and is a pixel of which distance from the starting point is closest among the pixels included in the respective four split areas.

10. The method of claim 7, wherein,
a straight line intersecting the plurality of areas represents a boundary of two straight lines defining a pixel, not a line defining a specific pixel, and
the pixel included in any one of the plurality of areas is not included in a remaining area among the plurality of areas.

11. The method of claim 7, wherein,
based on the pixel value of an area of the input image being not changed, the input image is split into an area of which the pixel value is not change and a remaining area, and
the generation of the integral image is performed only for the remaining area.

12. The method of claim 7, wherein,
the plurality of areas includes a first area and a second area, which are different with each other,
an average value of the pixels included in the first area is greater than an average value of the pixels included in the second area, and
an area of the first area is smaller than an area of the second area.

13. A recording medium storing a program combined with a hardware computer device for executing a method for processing an integral image, the program comprising:
performing a first process of splitting an input image into a plurality of areas;
performing a second process of setting one of at least one intersection where the plurality of areas intersect as a starting point for generating an integral image;
performing a third process of generating a plurality of integral images for the plurality of areas based on the starting point; and
performing a fourth process of calculating a sum of pixel values in a specific area of the input image using the plurality of integral images.

14. The recording medium of claim 13, wherein,
the input image is split into four split areas, and
the generation module progresses the generation of the integral image for the four split areas in parallel manner.

15. The recording medium of claim 14, wherein a reference point of the generation of the integral image for the four split areas is set for each of the four split areas, and is a pixel of which distance from the starting point is closest among the pixels included in the respective four split areas.

16. The recording medium of claim 13, wherein,
a straight line intersecting the plurality of areas represents a boundary of two straight lines defining a pixel, not a line defining a specific pixel, and
the pixel included in any one of the plurality of areas is not included in a remaining area among the plurality of areas.

17. The recording medium of claim 13, wherein,
based on the pixel value of an area of the input image being not changed, the input image is split into an area of which the pixel value is not change and a remaining area, and
the generation of the integral image is performed only for the remaining area.

18. The recording medium of claim 13, wherein,
the plurality of areas includes a first area and a second area, which are different with each other,
an average value of the pixels included in the first area is greater than an average value of the pixels included in the second area, and
an area of the first area is smaller than an area of the second area.
